(19) United States
(12) Patent Application Publication
(10) Pub. No.: US 2023/0332818 A1
(43) Pub. Date: Oct. 19, 2023

(54) METHOD FOR CONTROLLING TEMPERATURE OF REFRIGERATOR, AND REFRIGERATOR

(71) Applicants: QINGDAO HAIER REFRIGERATOR CO., LTD., Qingdao, Shandong (CN); HAIER SMART HOME CO., LTD., Qingdao, Shandong (CN)

(72) Inventors: Lisheng JI, Qingdao, Shandong (CN); Feifei QI, Qingdao, Shandong (CN); Zhanpeng CUI, Qingdao, Shandong (CN); Zhiqiang HAN, Qingdao, Shandong (CN); Peng LI, Qingdao, Shandong (CN); Kai WANG, Qingdao, Shandong (CN)

(21) Appl. No.: 18/013,611

(22) PCT Filed: Jul. 9, 2021
(86) PCT No.: PCT/CN2021/105500

§ 371 Date: Dec. 29, 2022

(30) Foreign Application Priority Data
Jul. 13, 2020 (CN) 202010670624.X

(51) Int. Cl. F25D 17/04; F25D 11/02

(52) U.S. Cl. CPC F25D 17/045; F25D 11/02; F25D 2600/06; F25D 2700/12

(57) ABSTRACT

Provided are Aa method for controlling the temperature of a refrigerator, and a refrigerator. A refrigerato, comprising a cabinet, a thawing chamber, a refrigeration system and a micro-air-duct rotary disc (180), wherein a storage compartment is defined by the cabinet, and comprises a storage area and a thawing area, the thawing chamber is arranged in the thawing area The refrigeration system is started to generate cold airflow when the temperature of the storage area is greater than or equal to a preset storage start-up temperature threshold value, the guiding direction of the cold airflow is determined by means of comparing the temperature of the thawing chamber with a preset thawing shutdown temperature threshold value, and the directional guidance of the cold airflow is completed by means of the micro-air-duct rotary disc .

### FIELD OF THE INVENTION

The present invention relates to the field of refrigeration, and particularly relates to a method for controlling the temperature of a refrigerator, and a refrigerator.

### BACKGROUND OF THE INVENTION

Frozen food materials can maintain the freshness, nutritional value and original flavor to the maximum extent in the cryopreservation process. There are two main ways to preserve frozen food materials in traditional refrigerators. One is long-term low-temperature storage at -14° C. to -24° C., and the other is short-term soft freezing storage at about -4° C. However, when undergoing long-term low-temperature storage, a food material needs to be thawed for a long time before it is handled, which is inconvenient for a user to handle the food material quickly; and when the food material undergoes short-term soft freezing storage, there would be problems of long time for the food material to undergo an ice crystal zone during freezing, poor preservation effect and short storage time. Therefore, there is an urgent need to provide a solution for storing a food material that enables the food material to quickly undergo the ice crystal zone and to be ready to eat.

### BRIEF DESCRIPTION OF THE INVENTION

One objective of the present invention is to overcome at least one technical defect of the prior art and to provide a method for controlling the temperature of a refrigerator, and a refrigerator that have both the advantage of enabling a food material to quickly undergo an ice crystal zone and the advantage of enabling the food material to be ready to eat.

One further objective of the present invention is to ensure that normal temperature control can be maintained in both the storage area and the thawing area of the storage compartment.

Another further objective of the present invention is to use a micro-air-duct rotary disc to meet the refrigeration requirements of the storage area and the thawing area, which can effectively reduce the switching of a solenoid valve, thus prolonging the service life of the solenoid valve.

Specifically, the present invention provides a method for controlling the temperature of a refrigerator. The refrigerator includes a cabinet, in which is defined a storage compartment, the storage compartment including a storage area and a thawing area; a thawing chamber, arranged in the thawing area; a refrigeration system, configured to generate cold airflow; and a micro-air-duct rotary disc, configured to make the cold airflow selectively enter the storage area and the thawing chamber. The method for controlling the temperature of the refrigerator includes:
controlling, when the temperature of the storage area is greater than or equal to a preset storage start-up temperature threshold value, a refrigeration system to start;
acquiring the temperature of the thawing chamber, and comparing the temperature of the thawing chamber with a preset thawing shutdown temperature threshold value;
controlling, if the temperature of the thawing chamber is greater than or equal to the preset thawing shutdown temperature threshold value, the micro-air-duct rotary disc to simultaneously guide the cold airflow to the storage area and the thawing chamber; and
controlling, if the temperature of the thawing chamber is lower than the preset thawing shutdown temperature threshold value, the micro-air-duct rotary disc to entirely guide the cold airflow to the storage area, so as to refrigerate the storage area separately.

Optionally, after the step of controlling the micro-air-duct rotary disc to simultaneously guide the cold airflow to the storage area and the thawing chamber, the method further includes:
controlling, when the temperature of the storage area decreases to a preset storage shutdown temperature threshold value and the temperature of the thawing chamber is still higher than the preset thawing shutdown temperature threshold value, the micro-air-duct rotary disc to entirely guide the cold airflow to the thawing chamber; and
the step of controlling, if the temperature of the thawing chamber is lower than the preset thawing shutdown temperature threshold value, the micro-air-duct rotary disc to entirely guide the cold airflow to the storage area includes:
   controlling, when the temperature of the thawing chamber decreases to the preset thawing shutdown temperature threshold value and the temperature of the storage area is still higher than the preset storage shutdown temperature threshold value, the micro-air-duct rotary disc to entirely guide the cold airflow to the storage area.

Optionally, after the step of controlling the micro-air-duct rotary disc to entirely guide the cold airflow to the thawing chamber, the method further includes: stopping refrigerating the thawing chamber when the temperature of the thawing chamber decreases to the preset thawing shutdown temperature threshold value; and

after the step of controlling the micro-air-duct rotary disc to entirely guide the cold airflow to the storage area, the method further includes: stopping refrigerating the storage area when the temperature of the storage area decreases to the preset storage area shutdown temperature threshold value.

Optionally, the refrigerator further includes a heating unit, configured to thaw the thawing chamber, and the method for controlling the temperature of the refrigerator further includes:
detecting, when stopping refrigerating the thawing chamber, an event of placing an object to be handled in the thawing chamber;
acquiring, when it is detected that the object to be handled is placed in the thawing chamber, attribute information of the object to be handled;
determining operation parameters of the heating unit according to the attribute information; and
controlling operation of the heating unit according to the operation parameters.

Optionally, the attribute information includes any one of the following items:

a type of the object to be handled, a boundary dimension of the object to be handled, and the temperature of the object to be handled.

Optionally, when the attribute information includes the temperature of the object to be handled, the step of determining the operation parameters of the heating unit according to the attribute information includes:
calculating a temperature difference between the temperature of the object to be handled and a thawing chamber shutdown temperature threshold value; and
determining starting time of the heating unit according to the temperature difference.

Optionally, the temperature of the object to be handled includes a surface temperature and/or a central temperature of the object to be handled.

Based on the same inventive concept, the present invention further provides a refrigerator, which includes:
a cabinet, in which is defined at least one storage compartment;
a thawing chamber, arranged in the at least one storage compartment;
a refrigeration system, configured to generate cold airflow during working;
a micro-air-duct rotary disc, configured to make the cold airflow selectively enter the at least one storage compartment and the thawing chamber; and
a control module, including a memory and a processor, where the memory stores a control program, and when being executed by the processor, the control program is used for implementing the method for controlling the temperature of the refrigerator according to any one of the embodiments of the present invention.

Optionally, the refrigerator further includes:

a thermal baffle, arranged in the storage compartment and configured to separate the storage compartment into a storage area and a thawing area.

Optionally, the refrigerator further includes:
a first temperature sensor, arranged in the storage area and configured to detect the temperature of the storage area; and
a second temperature sensor, arranged in the thawing chamber and configured to detect the temperature of the thawing area.

The present invention provides the method for controlling the temperature of the refrigerator, and the refrigerator. In the method for controlling the temperature of the refrigerator provided in the present invention, the refrigeration system is started to generate the cold airflow when the temperature of the storage area is greater than or equal to the preset storage start-up temperature threshold value, a guiding direction of the cold airflow is determined by comparing the temperature of the thawing chamber with the preset thawing shutdown temperature threshold value, and the directional guidance of the cold airflow is completed by means of the micro-air-duct rotary disc, thereby meeting different refrigeration requirements of the storage area and the thawing area; and in the refrigeration process, not only can the use of a solenoid valve be reduced, but also the switching times of the solenoid valve can be effectively reduced, thereby prolonging the service life of the solenoid valve.

Further, according to the present invention, the starting time of the heating unit can be determined according to the temperature difference between the temperature of the object to be handled and the preset thawing shutdown temperature threshold value, so as to reasonably control the thawing time and avoid the degradation of food quality due to excessive thawing.

Further, according to the present invention, by arranging the thermal baffle, the storage compartment can be separated into the storage area and the thawing area, and thus the thawing chamber is arranged in the thawing area, which can effectively isolate the heat exchange between the thawing chamber and the storage area, thereby reducing the refrigeration influence of the storage area on the thawing chamber.

These and other objectives, advantages and features of the present invention will be better understood by those skilled in the art in the light of the detailed description of specific embodiments of the present invention in conjunction with the accompanying drawings below.

### BRIEF DESCRIPTION OF THE DRAWINGS

Some specific embodiments of the present invention will be described below in detail in an exemplary rather than a limiting manner with reference to the accompanying drawings. Identical reference numerals in the accompanying drawings indicate identical or similar components or parts. It should be understood by those skilled in the art that these accompanying drawings are not necessarily drawn to scale. In the accompanying drawings:

FIG. 1 is a schematic section view of a refrigerator according to an embodiment of the present invention, showing a flow path of cold airflow for refrigerating a storage area and a thawing area;

FIG. 2 is a schematic section view of an air duct cover plate according to an embodiment of the present invention;

FIG. 3 is a schematic diagram of a method for controlling the temperature of a refrigerator according to an embodiment of the present invention;

FIG. 4 is a schematic diagram of a method for controlling the temperature of a refrigerator according to another embodiment of the present invention;

FIG. 5 is a flow chart of a method for controlling the temperature of a refrigerator according to an embodiment of the present invention;

FIG. 6 is a flow chart of a method for controlling the temperature of a refrigerator according to another embodiment of the present invention; and

FIG. 7 is a flow chart of a method for controlling the temperature of a refrigerator according to yet another embodiment of the present invention.

### DETAILED DESCRIPTION

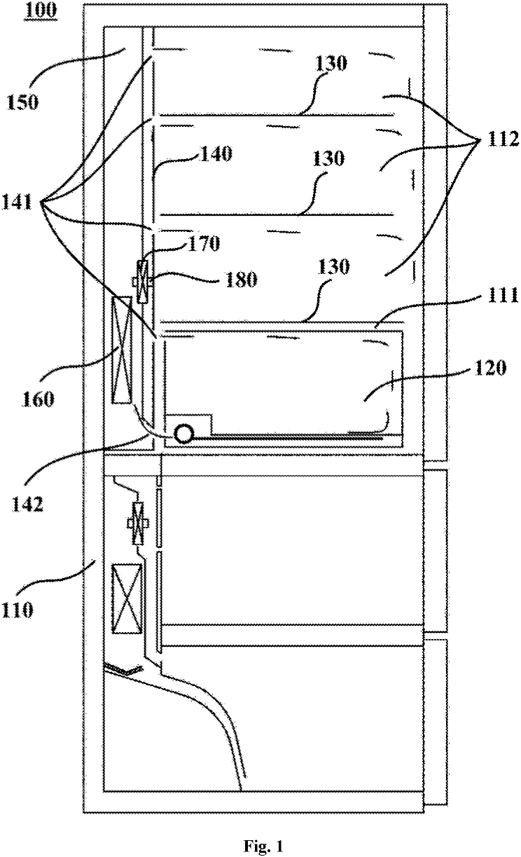

FIG. 1 is a schematic section view of a refrigerator according to an embodiment of the present invention, showing a flow path of cold airflow for refrigerating a storage area and a thawing area. Referring to FIG. 1, a refrigerator 100 may include a cabinet 110, a thawing chamber 120, a refrigeration system, a micro-air-duct rotary disc 180 and a control module.

The cabinet 110 may define a storage compartment, and the storage compartment may include one or more storage areas 112 and one thawing area 111. The thawing chamber 120 may be arranged in the thawing area 111. In some embodiments, there may be a plurality of storage compartments, and in the illustrated embodiment, the cabinet 110 defines two storage compartments. Both of the storage compartments are opened forwards. In some other embodiments, the storage compartments may also be opened upwards.

In the case where the cabinet 110 defines two storage compartments, the storage compartments may include a refrigerating compartment and a freezing compartment. As known to those skilled in the art, the refrigerating compartment refers to a storage compartment where the preservation temperature of food materials is 0 to 8° C.; and the freezing compartment refers to a storage compartment where the preservation temperature of the food materials is -24° C. to -14° C. The thawing chamber 120 may be arranged in the refrigerating compartment, so as to reduce the impact of thawing or maintaining soft freezing temperature on the food materials preserved in the storage compartment.

The refrigeration system may be configured to generate cold airflow. Specifically, the refrigeration system may include a compressor, a condenser, a throttling element and an evaporator.

The micro-air-duct rotary disc 180 may be configured to make the cold airflow selectively enter the storage area 112 and the thawing chamber 120. The cold airflow may undergo heat exchange with air inside the storage area 112 or the thawing chamber 120, so as to reduce the temperature of the storage area 112 or the thawing chamber 120, thus meeting refrigeration requirements of the storage compartment and the thawing chamber 120.

Further, the refrigerator 100 may further include thermal baffles 130, which are arranged in the storage compartment and configured to separate the storage compartment into the storage area 112 and the thawing area 111. The thawing chamber 120 is arranged in the thawing area 111. In the illustrated embodiment, the thermal baffles 130 are all arranged to extend in a horizontal direction. In the embodiments of the present invention, by arranging the thermal baffles 130, the storage compartment where the thawing chamber 120 is located can be separated into a thawing area 111 and at least one storage area 112, and then the thawing chamber 120 is arranged in the thawing area 111, which can effectively isolate heat exchange between the thawing chamber 120 and the storage area 112 and reduce the refrigeration influence of the storage area 112 on the thawing chamber 120. The thawing area 111 may be arranged below the storage area 112.

In some other embodiments, the refrigerator 100 may further be provided with thermal baffles that extend in a vertical direction, and the thermal baffles extending in the horizontal direction and the thermal baffles extending in the vertical direction can be peripherally arranged on the outer side of the thawing chamber 120 in an end-to-end connection mode. Therefore, the heat exchange between the thawing chamber 120 and the storage area 112 may be further isolated, thereby ensuring the thermal insulation property of the thawing chamber 120.

The control module may include a memory and a processor. The memory may store a control program, when being executed by the processor, the control program is used for implementing the method for controlling the temperature of the refrigerator according to any one of the embodiments of the present invention. The control module may be arranged on an electrical control panel of the refrigerator to facilitate installation and maintenance of the control module.

In some embodiments, the refrigerator 100 may include a first temperature sensor and a second temperature sensor. The first temperature sensor may be arranged in the storage area 112 to detect the temperature of the storage area 112. The second temperature sensor may be arranged in the thawing chamber 120 to detect the temperature of the thawing chamber 120. The first temperature sensor and the second temperature sensor may detect the temperature of the storage area and the temperature of the thawing chamber respectively, which is convenient to control the temperature of the storage area 112 and the temperature of the thawing chamber 120.

In some embodiments, the refrigerator 100 may further include a heating unit. The heating unit may be configured to thaw the thawing chamber 120. Specifically, the heating unit may include an electromagnetic wave generation system which is at least partially arranged in the thawing chamber 120 or communicated to the inside of the thawing chamber 120. The electromagnetic wave generation system may be configured to generate electromagnetic waves to thaw an object to be handled. The electromagnetic wave generation system may be at least partially arranged on the outer side of the cabinet 110 to avoid fluctuations in the temperature of the compartment caused by the generated heat. The outer side of the cabinet 110 herein refers to the side of the cabinet 110 exposed to ambient air, and the inner side of the cabinet 110 refers to the storage compartment.

The electromagnetic wave generation system may include an electromagnetic wave generation module, configured to generate an electromagnetic wave signal; a power supply module, electrically connected with the electromagnetic wave generation module and configured to supply electric energy to the electromagnetic wave generation module to make the electromagnetic wave generation module generate the electromagnetic wave signal; a radiating antenna, electrically connected with the electromagnetic wave generation module and configured to radiate electromagnetic waves at a corresponding frequency according to the electromagnetic wave signal to thaw the object to be handled in the thawing chamber 120; and a signal processing and measurement and control circuit, configured to detect characteristic parameters of the electromagnetic waves.

The electromagnetic wave generation module and the power supply module may be arranged on the outer side of the cabinet 110. The signal processing and measurement and control circuit may be arranged at the bottom of the thawing chamber 120. The signal processing and measurement and control circuit may be integrated on a circuit board, so as to facilitate installation and maintenance of the signal processing and measurement and control circuit.

In some embodiments, the refrigerator 100 may be an air-cooled refrigerator. Each storage compartment may be internally provided with an air duct cover plate 140 respectively, so as to separate a refrigeration air duct 150 in the inside of each storage compartment. Each refrigeration air duct 150 may be provided with an evaporator 160 and a refrigeration fan 170 respectively, so as to enable the refrigeration system to refrigerate one of the storage compartments separately. Of course, in the case where the cabinet defines a plurality of storage compartments, an evaporator 160 and a refrigeration fan 170 may also be arranged in only one of the refrigeration air ducts 150, and the refrigeration air duct 150 where the evaporator 160 is located optionally communicates with other refrigeration air ducts 150. In this embodiment, the refrigeration air duct 150 where the evaporator 160 is located optionally communicates with other refrigeration air ducts 150, thus the refrigeration system may only refrigerate the storage compartment where the evaporator 160 is located or refrigerate a plurality of storage compartments at the same time.

At least one air supply outlet 141 and an air return inlet 142 may be formed in each air duct cover plate 140, so as to circulate air in the corresponding storage compartment for refrigeration. There may be a plurality of air supply outlets 141. An air supply outlet 141 and an air return inlet 142 may be formed in the thawing chamber 120, so as to circulate air in the thawing chamber 120 for refrigeration. The air return inlet 142 may be formed below the plurality of air supply outlets 141, so as to make refrigeration more adequate.

In some other embodiments, the refrigerator 100 may also be a direct cooling refrigerator. That is, each storage compartment may be provided with an evaporator 160 and cold is transferred by means of natural convection.

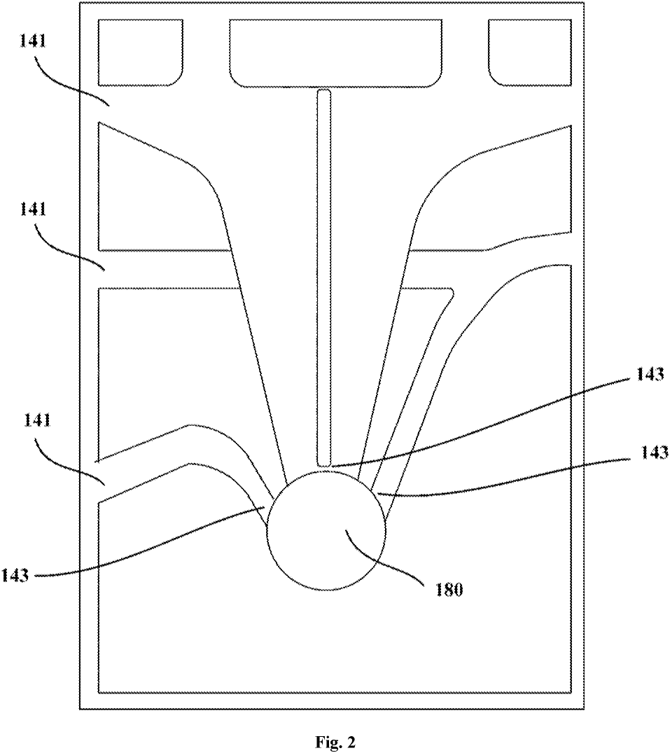

FIG. 2 is a schematic section view of the air duct cover plate 140 according to an embodiment of the present invention. Referring to FIG. 2, in some embodiments, the air duct cover plate 140 may be clamped into the rear wall of the storage compartment to from an air return portion of the refrigeration air duct 150, and the evaporator 160 may be arranged in the air return portion. The air duct cover plate 140 itself may be provided with at least one air supply portion of a compartment duct, and each air supply portion may be provided with at least one air supply outlet 141 and an air inlet 143.

The micro-air-duct rotary disc 180 may be configured to be a volute capable of containing the refrigeration fan 170. The volute is configured to be rotatable and to make its air outlet in butt joint with the air inlet 143 of one air supply portion, so as to convey cold airflow refrigerated by the evaporator 160 to the air supply portion and blow it out from the air supply outlet 141 of the air supply portion.

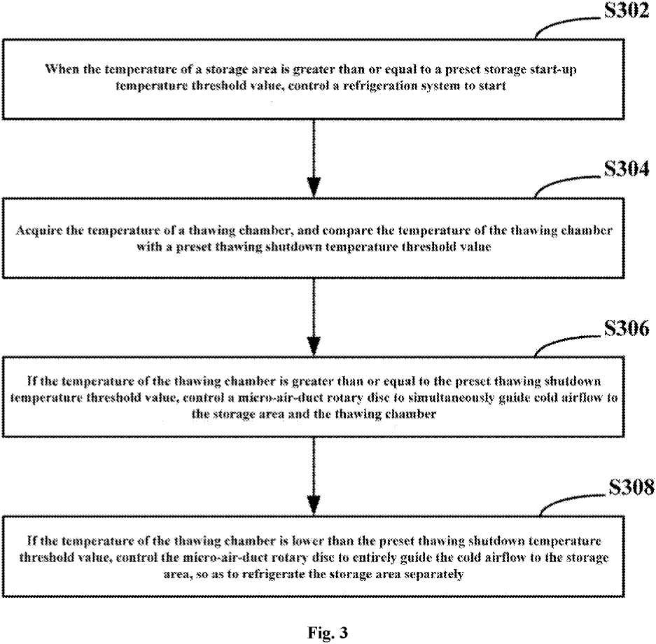

FIG. 3 is a schematic diagram of a method for controlling the temperature of a refrigerator according to an embodiment of the present invention. Referring to FIG. 3, in this embodiment, the method for controlling the temperature of the refrigerator may include steps S302 to S308.

Step S302, when the temperature of a storage area is greater than or equal to a preset storage start-up temperature threshold value, a refrigeration system is controlled to start; and after starting, the refrigeration system may generate cold airflow.

Step S304, the temperature of a thawing chamber is acquired, and the temperature of the thawing chamber is compared with a preset thawing shutdown temperature threshold value.

Step S306, if the temperature of the thawing chamber is greater than or equal to the preset thawing shutdown temperature threshold value, a micro-air-duct rotary disc is controlled to simultaneously guide the cold airflow to the storage area and the thawing chamber.

Step S308, if the temperature of the thawing chamber is lower than the preset thawing shutdown temperature threshold value, the micro-air-duct rotary disc is controlled to entirely guide the cold airflow to the storage area, so as to refrigerate the storage area separately.

In the embodiments of the present invention, the refrigeration system is started to generate the cold airflow when the temperature of the storage area is greater than or equal to the storage start-up temperature threshold value, a guiding direction of the cold airflow is determined by comparing the temperature of the thawing chamber with the preset thawing shutdown temperature threshold value, and the directional guidance of the cold airflow is completed by means of the micro-air-duct rotary disc, thereby meeting different refrigeration requirements of the storage area and the thawing chamber; and in the process of controlling the temperature of the compartment, a solenoid valve does not need to be frequently switched, thereby effectively prolonging the service life of the solenoid valve.

Considering that during refrigeration of the storage area 112 or the thawing chamber 120, the temperature of the storage area or the temperature of the thawing chamber 120 will decrease, as for step S306, in some embodiments, after the micro-air-duct rotary disc 180 is controlled to simultaneously guide the cold airflow to the storage area 112 and the thawing chamber 120, when the temperature of the storage area 112 decreases to a preset storage shutdown temperature threshold value and the temperature of the thawing chamber 120 is still higher than the preset thawing shutdown temperature threshold value, the micro-air-duct rotary disc 180 may also be controlled to entirely guide the cold airflow to the thawing chamber 120, so as to refrigerate the thawing chamber 120 separately. In this case, the temperature of the thawing chamber 120 will decrease quickly, such that a food material placed in the thawing chamber 120 undergoes an ice crystal zone quickly, which is conducive to food preservation.

In some further embodiments, after the micro-air-duct rotary disc 180 is controlled to entirely guide the cold airflow to the thawing chamber 120, when the temperature of the thawing chamber 120 decreases to the preset thawing shutdown temperature threshold value, refrigeration of the thawing chamber 120 may also be stopped. Since the temperature of the storage area 112 decreases to the preset storage shutdown temperature threshold value firstly, refrigeration of the storage area 112 will be stopped firstly; and then, when the temperature of the thawing chamber 120 decreases to the preset thawing shutdown temperature threshold value, refrigeration of the thawing chamber 120 is stopped, so as to enable both the refrigeration requirement of the storage area 112 and the refrigeration requirement of the thawing chamber 120 to be met, thereby ensuring that normal temperature control can be maintained in both the storage area and the thawing chamber 120.

As for step S306, in some other embodiments, after the micro-air-duct rotary disc 180 is controlled to simultaneously guide the cold airflow to the storage area 112 and the thawing chamber 120, when the temperature of the thawing chamber 120 decreases to the preset thawing shutdown temperature threshold value and the temperature of the storage area 112 is still higher than the preset storage shutdown temperature threshold value, the micro-air-duct rotary disc 180 may also be controlled to entirely guide the cold airflow to the storage area 112, so as to refrigerate the storage area 112 separately.

In some further embodiments, after the micro-air-duct rotary disc 180 is controlled to entirely guide the cold airflow to the storage area 112, when the temperature of the storage area 112 decreases to the preset storage area shutdown temperature threshold value, refrigeration of the storage area 112 may also be stopped. Since the temperature of the thawing chamber 120 decreases to the preset thawing shutdown temperature threshold value firstly, refrigeration of the thawing chamber 120 will be stopped firstly,; and then, when the temperature of the storage area 112 decreases to the preset storage shutdown temperature threshold value, refrigeration of the storage area 112 is stopped, so as to enable both the refrigeration requirement of the storage area and the refrigeration requirement of the thawing chamber 120 to be met, thereby ensuring that normal temperature control can be maintained in both the storage area 112 and the thawing chamber 120.

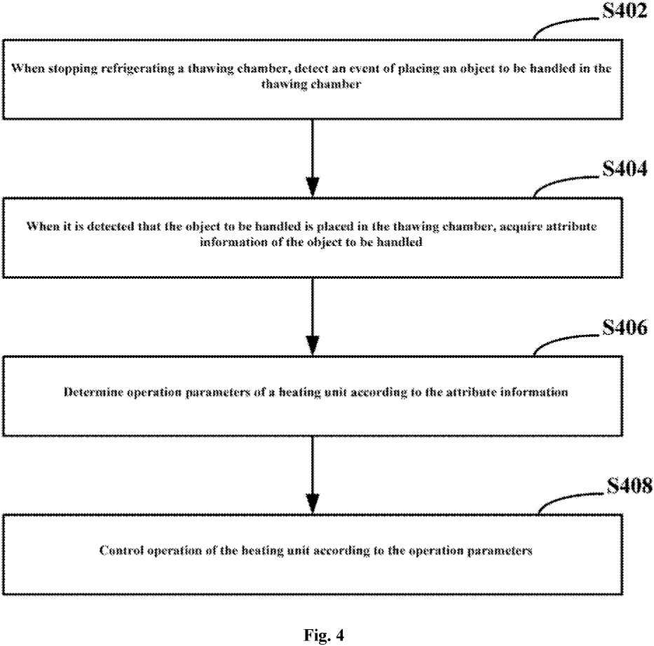

In order to facilitate thawing of frozen food materials, in some embodiments, the refrigerator 100 may further include a heating unit. The heating unit may be configured to thaw the thawing chamber 120. FIG. 4 is a flow chart of a method for controlling the temperature of a refrigerator according to another embodiment of the present invention. Referring to FIG. 4, in this embodiment, the method for controlling the temperature of the refrigerator may also include steps S402 to S408.

Step S402, when refrigeration of the thawing chamber 120 is stopped, an event of placing an object to be handled in the thawing chamber 120 is detected. The object to be handled generally refers to a food material/food that needs to be placed into the refrigerator for freezing, thawing or refrigerating.

Step S404, when it is detected that the object to be handled is placed in the thawing chamber 120, attribute information of the object to be handled is acquired. The attribute information may include a type of the object to be handled, a boundary dimension of the object to be handled, and/or the temperature of the object to be handled. The temperature of the object to be handled includes a surface temperature and/or a central temperature of the object to be handled.

Step S406, operation parameters of the heating unit are determined according to the attribute information. The operation parameters include but are not limited to starting time, stopping time and power of the heating unit.

Step S408, operation of the heating unit is controlled according to the operation parameters.

In this embodiment, when the object to be handled is placed in the thawing chamber 120, the attribute information of the object to be handled can be acquired, then the operation parameters of the heating unit can be determined according to the attribute information, and the operation of the heating unit is controlled based on the operation parameters, such that a better thawing effect can be achieved and the problem of degradation of food quality caused by thawing can be reduced.

In some embodiments, when the attribute information includes the temperature of the object to be handled, step S406 may include: a temperature difference between the temperature of the object to be handled and a thawing chamber shutdown temperature threshold value is calculated; and the starting time of the heating unit is determined according to the temperature difference. In this embodiment, the starting time of the heating unit is determined according to the temperature difference between the temperature of the object to be handled and the thawing chamber shutdown temperature threshold value, which makes the thawing time more reasonable and reduces the problem of degradation of food quality due to excessive thawing.

A first preset temperature threshold value and a second preset temperature threshold value can be determined according to thawing experiments of the thawing chamber 120. The second preset temperature threshold value may be set to 0° C., so as to make the thawing chamber 120 in a minus temperature thawing state during thawing. Of course, the first preset temperature threshold value and the second preset temperature threshold value may also be set to a certain threshold value range, respectively.

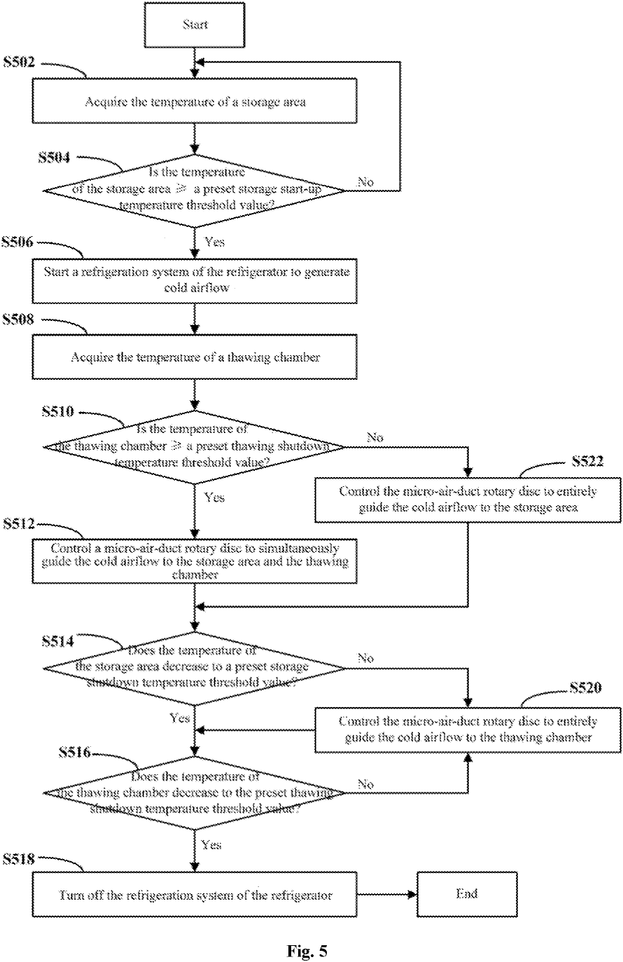

FIG. 5 is a flow chart of a method for controlling the temperature of a refrigerator according to an embodiment of the present invention. Referring to FIG. 5, in this embodiment, the method for controlling the temperature of the refrigerator may include steps S502 to S524.

Step S502, the temperature of a storage area is acquired.

Step S504, whether the temperature of the storage area is greater than or equal to a preset storage start-up temperature threshold value is determined; if yes, step S506 is performed; and if no, step S502 continues to be performed.

Step S506, a refrigeration system of the refrigerator is started to generate cold airflow.

Step S508, the temperature of a thawing chamber is acquired.

Step S510, whether the temperature of the thawing chamber is greater than or equal to a preset thawing shutdown temperature threshold value is determined; if yes, step S512 is performed; and if no, step S522 is performed.

Step S512, a micro-air-duct rotary disc is controlled to simultaneously guide the cold airflow to a refrigerating compartment and the thawing chamber.

Step S514, whether the temperature of the storage area decreases to a preset storage shutdown temperature threshold value is determined; if yes, step S516 is performed; and if no, step S520 is performed.

Step S516, whether the temperature of the thawing chamber decreases to the preset thawing shutdown temperature threshold value is determined; if yes, step S518 is performed; and if no, step S520 is performed.

Step S518, the refrigeration system of the refrigerator is turned off.

Step S520, the micro-air-duct rotary disc is controlled to entirely guide the cold airflow to the thawing chamber.

Step S522, the micro-air-duct rotary disc is controlled to entirely guide the cold airflow to the storage area.

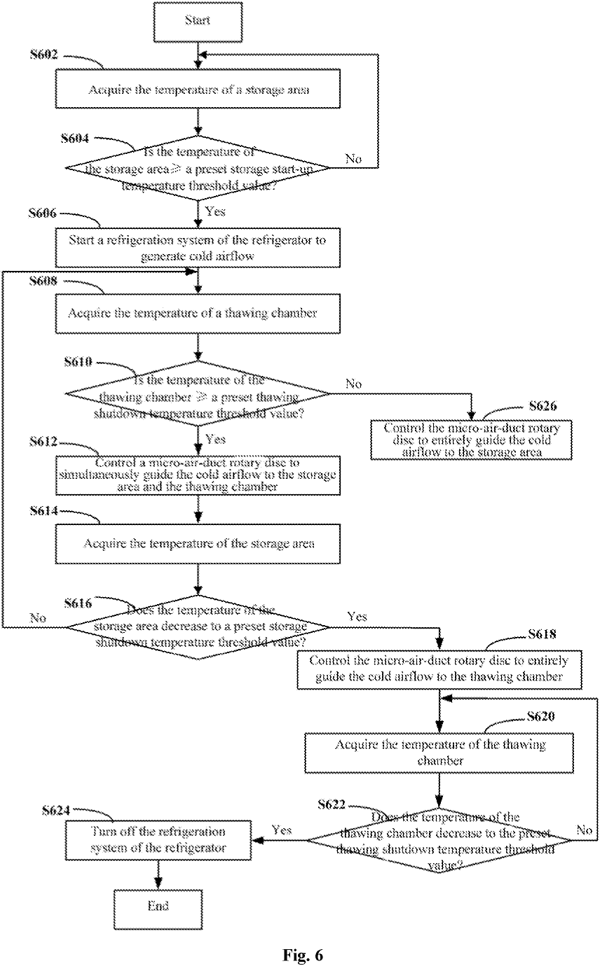

FIG. 6 is a flow chart of a method for controlling the temperature of a refrigerator according to another embodiment of the present invention. Referring to FIG. 6, in this embodiment, the method for controlling the temperature of the refrigerator may include steps S602 to S626.

Step S602, the temperature of a storage area is acquired.

Step S604, whether the temperature of the storage area is greater than or equal to a preset storage start-up temperature threshold value is determined; if yes, step S606 is performed; and if no, step S602 continues to be performed.

Step S606, a refrigeration system of the refrigerator is started to generate cold airflow.

Step S608, the temperature of a thawing chamber is acquired.

Step S610, whether the temperature of the thawing chamber is greater than or equal to a preset thawing shutdown temperature threshold value is determined; if yes, step S612 is performed; and if no, step S626 is performed.

Step S612, a micro-air-duct rotary disc is controlled to simultaneously guide the cold airflow to the storage area and the thawing chamber.

Step S614, the temperature of the storage area is acquired.

Step S616, whether the temperature of the storage area decreases to a preset storage shutdown temperature threshold value is determined; if no, it returns to step S608; and if yes, step S618 is performed.

Step S618, the micro-air-duct rotary disc is controlled to entirely guide the cold airflow to the thawing chamber.

Step S620, the temperature of the thawing chamber is acquired.

Step S622, whether the temperature of the thawing chamber decreases to the preset thawing shutdown temperature threshold value is determined; if yes, it returns to step S620; and if no, step S624 is performed.

Step S624, the refrigeration system of the refrigerator is turned off.

Step S626, the micro-air-duct rotary disc is controlled to entirely guide the cold airflow to the storage area.

In this embodiment, since the temperature of the storage area 112 decreases to the preset storage shutdown temperature threshold value firstly, refrigeration of the storage area 112 will be stopped firstly, and the cold airflow is entirely guided to the thawing chamber 120; and then, when the temperature of the thawing chamber 120 decreases to the preset thawing shutdown temperature threshold value, the refrigeration system is turned off, and thus refrigeration of the thawing chamber 120 is stopped, so as to enable both the refrigeration requirement of the storage area 112 and the refrigeration requirement of the thawing chamber 120 to be met, which not only makes the food material in the thawing chamber 120 undergo an ice crystal zone quickly, but also ensures that normal temperature control can be maintained in both the storage area and the thawing area 120.

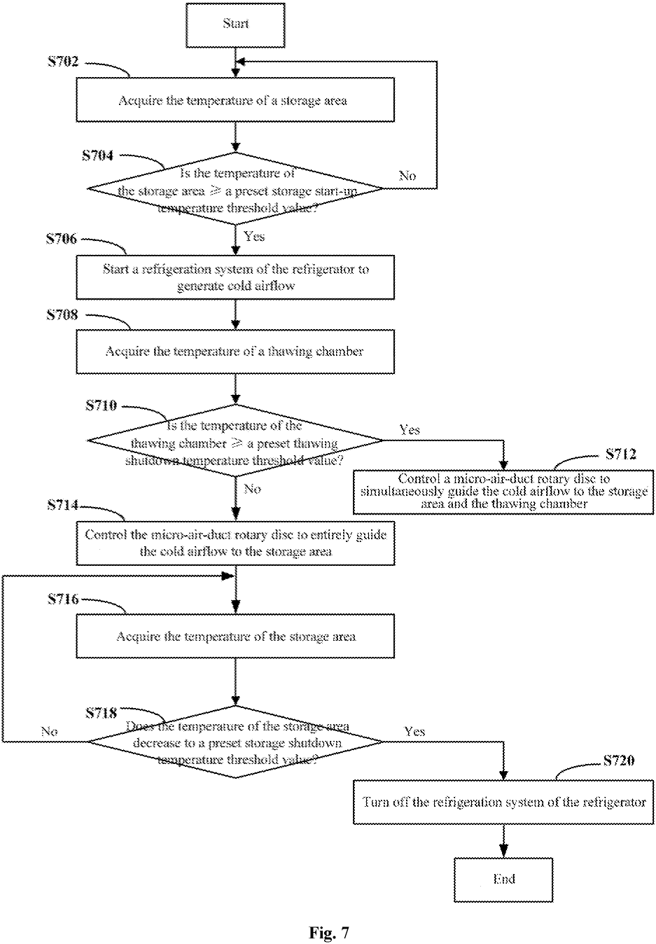

FIG. 7 is a flow chart of a method for controlling the temperature of a refrigerator according to yet another embodiment of the present invention. Referring to FIG. 7, in this embodiment, the method for controlling the temperature of the refrigerator may include steps S702 to S720.

Step S702, the temperature of a storage area is acquired.

Step S704, whether the temperature of the storage area is greater than or equal to a preset storage start-up temperature threshold value is determined; if yes, step S706 is performed; and if no, step S702 continues to be performed.

Step S706, a refrigeration system of the refrigerator is started to generate cold airflow.

Step S708, the temperature of a thawing chamber is acquired.

Step S710, whether the temperature of the thawing chamber is greater than or equal to a preset thawing shutdown temperature threshold value is determined; if yes, step S712 is performed; and if no, step S714 is performed.

Step S712, a micro-air-duct rotary disc is controlled to simultaneously guide the cold airflow to the storage area and the thawing chamber.

Step S714, the micro-air-duct rotary disc is controlled to entirely guide the cold airflow to the storage area.

Step S716, the temperature of the storage area is acquired.

Step S718, whether the temperature of the storage area decreases to a preset storage shutdown temperature threshold value is determined; if no, it returns to step S716; and if yes, step S720 is performed.

Step S720, the refrigeration system of the refrigerator is turned off.

In this embodiment, since the temperature of the thawing chamber 120 decreases to the preset thawing shutdown temperature threshold value firstly, refrigeration of the thawing chamber 120 will be stopped firstly, and the cold airflow is entirely guided to the storage area 112; and then, when the temperature of the storage area 112 decreases to the preset storage shutdown temperature threshold value, the refrigeration system is turned off, such that refrigeration of the storage area 112 is stopped, so as to enable both the refrigeration requirement of the storage area 112 and the refrigeration requirement of the thawing chamber 120 to be met, thereby ensuring that normal temperature control can be maintained in both the storage area 112 and the thawing chamber 120. It should be noted that, one or more examples of the embodiments of the present invention are shown in the accompanying drawings. Each of the examples is provided by way of explanation of the present invention and is not a limitation of the present invention. In fact, it is apparent to those skilled in the art that various modifications and variations of the present invention may be made without departing from the scope or spirit of the present invention. For example, features shown or described as part of one embodiment may be used with another embodiment to produce yet another embodiment.

The embodiments of the present invention provide the method for controlling the temperature of the refrigerator, and the refrigerator. In the method for controlling the temperature of the refrigerator provided in the present invention, the refrigeration system is started to generate the cold airflow when the temperature of the storage area is greater than or equal to the preset storage start-up temperature threshold value, the guiding direction of the cold airflow is determined by comparing the temperature of the thawing chamber 120 with the preset thawing shutdown temperature threshold value, and the directional guidance of the cold airflow is completed by means of the micro-air-duct rotary disc, thereby meeting different refrigeration requirements of the storage area 112 and the thawing chamber 120; and in the refrigeration process, not only can the use of a solenoid valve be reduced, but also the switching times of the solenoid valve can be effectively reduced, thereby prolonging the service life of the solenoid valve.

Further, in the embodiments of the present invention, the starting time of the heating unit can also be determined according to the temperature difference between the temperature of the object to be handled and the preset thawing shutdown temperature threshold value, so as to reasonably control the thawing time and avoid the degradation of food quality due to excessive thawing.

Further, in the embodiments of the present invention, the thermal baffles 130 are also arranged in the refrigerator, and the storage compartment where the thawing chamber 120 is located can be separated into the thawing area 111 and the storage area 112, and thus the thawing chamber 120 is arranged in the thawing area, which can effectively isolate the heat exchange between the thawing chamber 120 and the storage area 112, thereby reducing the refrigeration influence of the storage area 112 on the thawing chamber 120.

At this point, it should be recognized by those skilled in the art that, although multiple exemplary embodiments of the present invention have been shown and described in detail herein, many other variations or modifications in accordance with the principles of the present invention may still be directly determined or derived from the disclosure of the present invention without departing from the spirit and scope of the present invention. Therefore, the scope of the present invention should be understood and recognized as covering all these other variations or modifications.

What is claimed is:

1. A method for controlling the temperature of a refrigerator, wherein the refrigerator comprises a cabinet, in which is defined a storage compartment, the storage compartment comprising a storage area and a thawing area; a thawing chamber, arranged in the thawing area; a refrigeration system, configured to generate cold airflow; and a micro-air-duct rotary disc, configured to make the cold airflow selectively enter the storage area and the thawing chamber; and the method comprises:
controlling, when the temperature of the storage area is greater than or equal to a preset storage start-up temperature threshold value, the refrigeration system to start;
acquiring the temperature of the thawing chamber, and comparing the temperature of the thawing chamber with a preset thawing shutdown temperature threshold value;
controlling, if the temperature of the thawing chamber is greater than or equal to the preset thawing shutdown temperature threshold value, the micro-air-duct rotary disc to simultaneously guide the cold airflow to the storage area and the thawing chamber; and
controlling, if the temperature of the thawing chamber is lower than the preset thawing shutdown temperature threshold value, the micro-air-duct rotary disc to entirely guide the cold airflow to the storage area, so as to refrigerate the storage area separately.

2. The method for controlling the temperature of the refrigerator according to claim 1, wherein after the step of controlling the micro-air-duct rotary disc to simultaneously guide the cold airflow to the storage area and the thawing chamber, the method further comprises:
controlling, when the temperature of the storage area decreases to a preset storage shutdown temperature threshold value and the temperature of the thawing chamber is still higher than the preset thawing shutdown temperature threshold value, the micro-air-duct rotary disc to entirely guide the cold airflow to the thawing chamber; and
the step of controlling, if the temperature of the thawing chamber is lower than the preset thawing shutdown temperature threshold value, the micro-air-duct rotary disc to entirely guide the cold airflow to the storage area comprises:
controlling, when the temperature of the thawing chamber decreases to the preset thawing shutdown temperature threshold value and the temperature of the storage area is still higher than the preset storage shutdown temperature threshold value, the micro-air-duct rotary disc to entirely guide the cold airflow to the storage area.

3. The method for controlling the temperature of the refrigerator according to claim 2, wherein
after the step of controlling the micro-air-duct rotary disc to entirely guide the cold airflow to the thawing chamber, the method further comprises: stopping refrigerating the thawing chamber when the temperature of the thawing chamber decreases to the preset thawing shutdown temperature threshold value; and
after the step of controlling the micro-air-duct rotary disc to entirely guide the cold airflow to the storage area, the method further comprises: stopping refrigerating the storage area when the temperature of the storage area decreases to the preset storage shutdown temperature threshold value.

4. The method for controlling the temperature of the refrigerator according to claim 3, wherein the refrigerator further comprises a heating unit, configured to thaw the thawing chamber, and the method further comprises:
detecting, when stopping refrigerating the thawing chamber, an event of placing an object to be handled in the thawing chamber;
acquiring, when it is detected that the object to be handled is placed in the thawing chamber, attribute information of the object to be handled; determining operation parameters of the heating unit according to the attribute information; and
controlling operation of the heating unit according to the operation parameters.

5. The method for controlling the temperature of the refrigerator according to claim 4, wherein the attribute information comprises any one of the following items:
a type of the object to be handled, a boundary dimension of the object to be handled, and the temperature of the object to be handled.

6. The method for controlling the temperature of the refrigerator according to claim 5, wherein when the attribute information comprises the temperature of the object to be handled, the step of determining the operation parameters of the heating unit according to the attribute information comprises:
calculating a temperature difference between the temperature of the object to be handled and a thawing chamber shutdown temperature threshold value; and
determining starting time of the heating unit according to the temperature difference.

7. The method for controlling the temperature of the refrigerator according to claim 6, wherein
the temperature of the object to be handled comprises a surface temperature and/or a central temperature of the object to be handled.

8. A refrigerator, comprising:
a cabinet, in which is defined at least one storage compartment;
a thawing chamber, arranged in the at least one storage compartment;
a refrigeration system, configured to generate cold airflow during working;
a micro-air-duct rotary disc, configured to make the cold airflow selectively enter the at least one storage compartment and the thawing chamber; and
a control module, comprising a memory and a processor, wherein the memory stores a control program, and when being executed by the processor, the control program is used for implementing the method for controlling the temperature of the refrigerator according to claim 1.

9. The refrigerator according to claim 8, further comprising:
a thermal baffle, arranged in the storage compartment and configured to separate the storage compartment into a storage area and a thawing area.

10. The refrigerator according to claim 9, further comprising:
a first temperature sensor, arranged in the storage area and configured to detect the temperature of the storage area; and
a second temperature sensor, arranged in the thawing chamber and configured to detect the temperature of the thawing area.
